(19) United States
(12) Patent Application Publication
(10) Pub. No.: US 2011/0088733 A1
(43) Pub. Date: Apr. 21, 2011

(54) WATER-BEARING DOMESTIC APPLIANCE

(75) Inventors: Johannes Büsing, Emersacker (DE); Stephan Lutz, Sontheim (DE); Bruno Reiter, Kosingen (DE); Michael Rosenbauer, Reimlingen (DE); Pedro Sancho, Zaragoza (ES)

(73) Assignee: BSH BOSCH UND SIEMENS HAUSGERATE GMBH, Munich (DE)

(21) Appl. No.: 12/933,092

(22) PCT Filed: Mar. 24, 2009
(86) PCT No.: PCT/EP09/53426

§ 371 Date: Sep. 17, 2010

(30) Foreign Application Priority Data
Mar. 28, 2008 (DE) 10 2008 016 171.3

(51) Int. Cl. B08B 3/00

(52) U.S. Cl. 134/198

(57) ABSTRACT

A water-bearing domestic appliance including a water diverter to distribute washing liquor. The water diverter has a carrier element that is a cast part in which lines for actuating the actuator are embedded. The water-bearing domestic appliance also includes an actuator that is fastened to the carrier element.

The invention relates to a water-bearing domestic appliance as claimed in the preamble of claim 1.

The deployment of actuatable components, such as display elements or electric motors or electromagnets serving as actuators for example, in water-bearing domestic appliances such as dishwashers or washing machines for example is generally known. Thus a distributor or water diverter is deployed as the final control element in a dishwasher, so that washing liquor is applied in an alternating manner in a switching operation to the upper and lower spray arms during a wash operation.

In such a generic domestic appliance, in particular a dishwasher, the electric actuator is fitted on the housing of the final control element by way of a carrier element. For the supply of power the actuator, generally an electric motor, is connected by way of electric lines to a corresponding connector. A position identification switch assigned to the actuator can also be connected for signal purposes by way of electric lines to an electric control facility. The fitting of the actuator to the housing of the final control element therefore involves a large number of components and is technically complex.

The object of the invention is to provide a domestic appliance, in particular a dishwasher, in which the actuator can be fitted in a technically simple manner to the housing of the final control element.

The object is achieved by the features of claim 1. Advantageous developments of the invention are disclosed in the subclaims.

The invention is based on a water-bearing domestic appliance, in particular a dishwasher or washing machine, at least featuring a water diverter to distribute washing liquor, said diverter featuring at least one carrier element to which an actuator is fastened.

The inventive solution is characterized in that the carrier element is a cast part, in which line means are embedded for actuating the component.

The line means are therefore configured to transmit electrical control signals or electrical energy and also to transmit optical control signals.

The electric lines are therefore integrated in the carrier element or are already prepositioned therein. When an actuator for example is fitted in the correct position on the carrier element, the connectors of the actuator can be brought automatically into electrical contact with the connectors of the electric lines prepositioned on the carrier element. However a cast part with corresponding characteristics for the transmission of optical signals can also be used as the carrier element.

Any suitable material can be used as the casting compound, as long as it satisfies the requirements relating to electrical resistance and/or optical characteristics. The carrier element can be produced in a simple manufacturing process using a plastic injection molding method, in which the electric lines are cast in the carrier element. In this process the electric lines can be stamped and/or bent in a simple manufacturing process from at least one sheet metal plate. The stamped sheet metal plate is then introduced as an insert into a plastic injection molding chamber and plastic injection molding material is cast around it. The electric lines embedded in the plastic material can be exposed with their contact points from the plastic material, a first of the contact points being able to be connected to the actuator and a second of the contact points being able to be connected to a power supply connector.

In a further embodiment a position identification switch can be assigned to the actuator, with which an electronic control facility captures the rotational position of a drive shaft of the actuator. To this end the switch is actuated during rotation of the drive shaft. The deployment of such switches to capture rotational position is generally known. Usually the switch is actively connected to the actuator in the manner of an additional component, perhaps a microswitch. According to the invention the position identification switch can be executed in a particularly simple manufacturing process by means of two mutually contactable switch contact points on the electric lines embedded in the carrier element.

For the switch to function correctly it is expedient to dispose the switch so that it is protected against interfering influences resulting from operation, such as vibrations, water, etc. For such a protected arrangement the carrier element can feature a plastic-free free space, in which the switch is disposed. The respective switch contact points of the electric lines preferably project out of the boundary walls of the free space. The arrangement within the free space means that the switch contact points are protected against external influences, which could result in incorrect switch actuation. To further enhance operating safety, the free space for the switch contact points configured in the carrier element can be closed around its periphery.

The contact points established in the carrier element for the electric lines embedded therein can be embodied as resilient contact arms for tolerance compensation purposes. The contact arms can also have grooves to enhance their flexibility.

For the purposes of dimensionally stable configuration the carrier element can feature a large-surface, plate-type support segment, on which the actuator is disposed and which can be bounded peripherally by a reinforcing wall. The electric lines can preferably be embedded in the plate-type support segment of the carrier element.

The abovementioned position identification switch can preferably be actuated by a cam element, which is assigned to the drive shaft of the actuator. Its cams can actuate the position identification switch during rotation of the drive shaft.

For an arrangement of the actuator on the housing of the final control element that is both favorable in respect of structural space and compact it may be advantageous for the drive shaft of the actuator not to be disposed directly on the final control element, for example a distributor disk, but at a distance from it. The actuator can then output to the final control element by way of an additional gear train. The gear elements, perhaps toothed wheels, of the gear train can be supported on a bearing segment of the carrier element. The bearing segment can in turn be molded to the carrier element with material uniformity and as a single piece. The carrier element can thus have the multiple function of supporting bearing segments for the gear train, the electric lines and/or the position identification switch.

In one simple embodiment of the gear train a first gear element of the gear train can rest on the drive shaft of the actuator. A second gear element connected thereto can rest on a force delivery shaft driving the final control element. To reduce the number of components, the cam element for actuating the position identification switch can be embodied with material uniformity and/or as a single piece with one of the gear elements. The bearing segment of the carrier element can be a journal for example, on which a hub segment of the gear element is supported in a rotatable manner. Alternatively the bearing segment can be a hollow cylindrical bearing stem, on the inner wall of which the hub segment of the gear element is supported in a rotatable manner.

To enhance functionality further, the carrier element can feature at least one latching element, which can be used to latch the actuator to the carrier element in a simple fitting process.

In a further embodiment the carrier element can also be embodied in the manner of a dish and/or together with the housing of the final control element can bound a gear chamber that is outwardly closed and in which the abovementioned gear train can be disposed.

In one particular embodiment the final control element can be a rotationally actuatable distributor disk of a water diverter or distributor disposed in the hydraulic circuit of a dishwasher. Washing fluid can therefore be applied to a lower or upper spray arm in the washing compartment of the dishwasher, depending on the switching state of the water diverter.

An exemplary embodiment of the invention is described below with reference to the accompanying figures, in which:

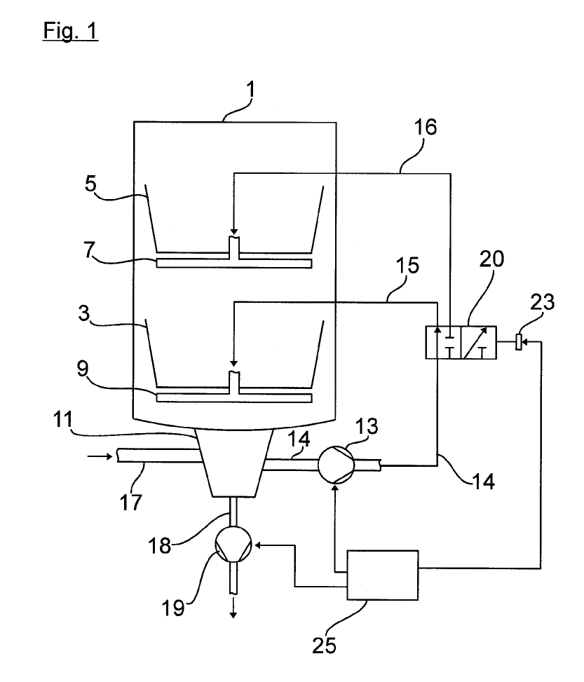

FIG. 1 shows a schematic block diagram of a domestic appliance in the form of a dishwasher;

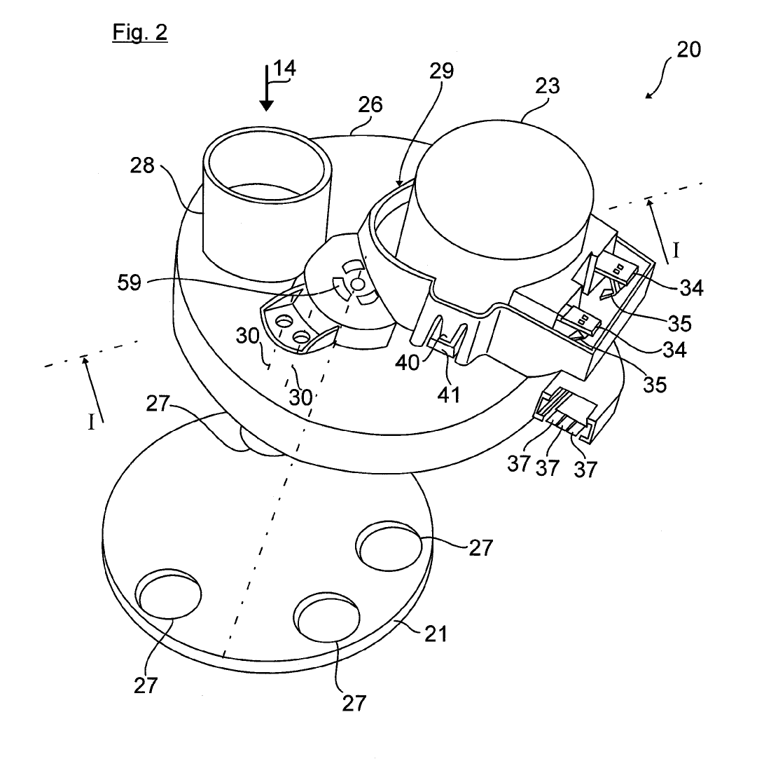

FIG. 2 shows an exploded view of a distributor housing half with assigned distributor disk;

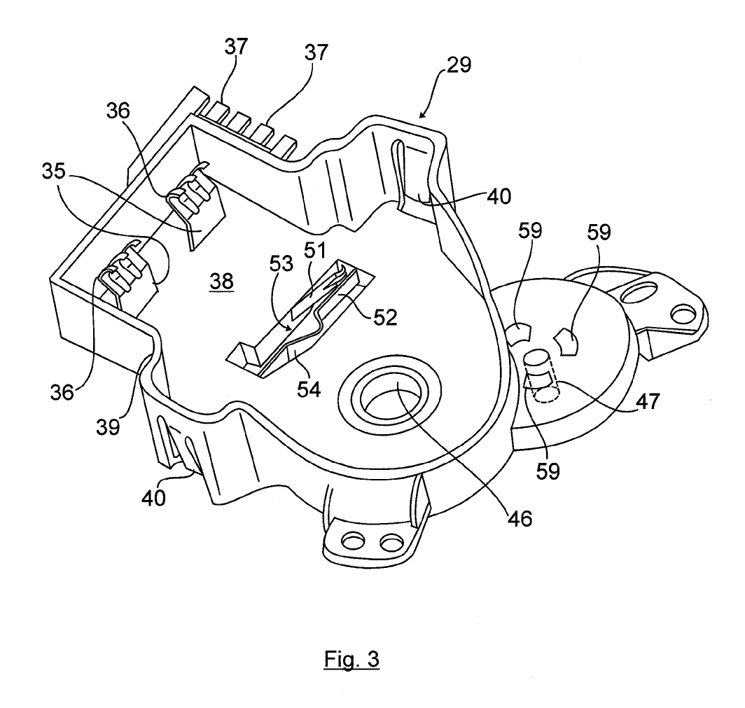

FIG. 3 shows an inventive carrier element to hold the actuator on the distributor housing;

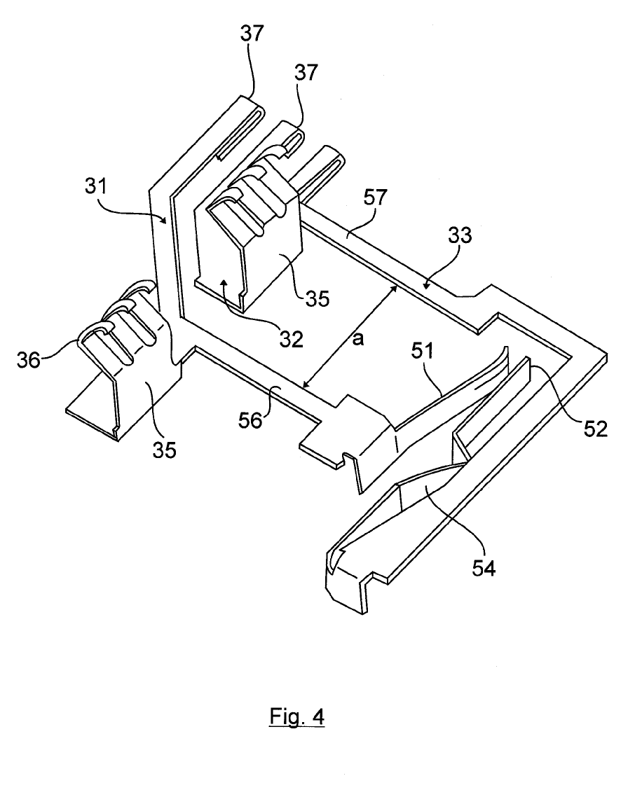

FIG. 4 shows the electric lines cast in the carrier element on their own; and

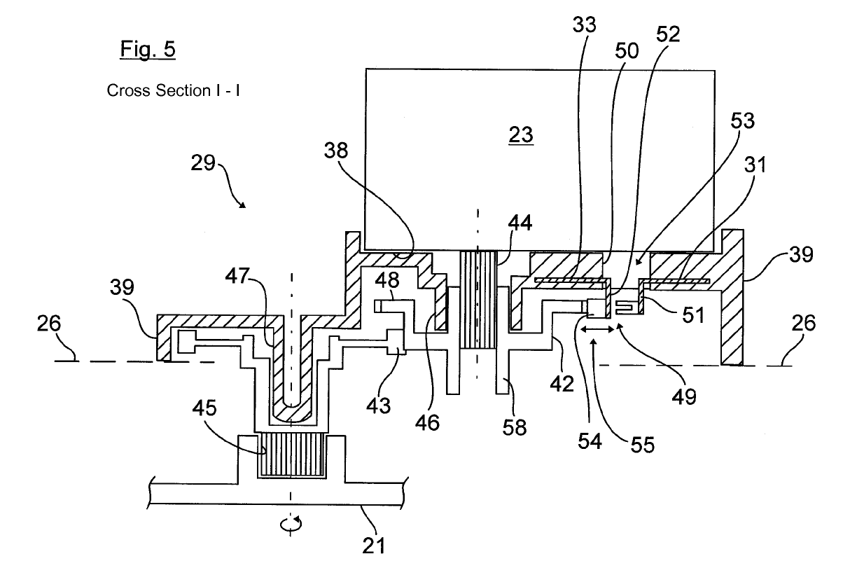

FIG. 5 shows a sectional diagram along the sectional plane 1-1 from FIG. 2.

FIG. 1 shows a rough schematic of a dishwasher having a washing compartment 1, in which items to be washed (not shown) can be disposed in racks 3, 5. In the washing compartment 1 shown two spray arms 7, 9 are disposed by way of example, being provided at two different spray levels, to apply washing fluid to the items to be washed. A pump sump with assigned circulation pump 13 is provided below the washing compartment floor, being connected for flow purposes by way of fluid lines 14, 15, 16 to the spray arms 7, 9. The pump sump 11 is also connected by way of connecting nozzles to a fresh water inlet 17 coupled to the water supply network and a discharge line 18, in which a liquor pump 19 is disposed to pump away dirty washing fluid from the washing compartment 1.

A water diverter or distributor 20 is present downstream of the circulation pump 13 in the fluid line 14 and is used during the wash operation of the dishwasher to apply washing fluid to the upper and lower spray arms 7, 9 in a switching operation. The distributor 20 shown in FIG. 1 generally as a switching valve can be switched between two switching states. In the first switching state, as shown in FIG. 1, the fluid line 15 to the lower spray arm 9 is activated during the wash operation, while the fluid line 16 to the upper spray arm 7 is decoupled from the hydraulic circuit. In contrast in the second switching state the fluid line 16 to the upper spray arm 7 is activated, while the fluid line 15 is decoupled from the hydraulic circuit.

As also shown in FIG. 1, an electric actuator 23 is assigned to the distributor 20, to switch the distributor 20 between the two switching states. Together with the circulation pump 13 and the liquor pump 19 the actuator 23 is connected for signal purposes to an electronic control facility 25, which controls the temporal program sequence of a wash operation of the dishwasher.

FIG. 2 shows an exploded view of a distributor housing half 26 of the distributor 20 with the actuator 23 fitted thereto, in this instance an electric motor. The distributor housing half 26 is configured as roughly pan-shaped in FIG. 2 with a hollow profile that is open at the bottom. In its interior a final control element 21 in the form of a distributor disk is supported in a rotatable manner, it being possible to adjust its rotational position by means of the actuator 23. The distributor disk 21 features control openings 27, which can overlay outlet openings (not shown) of the other distributor housing half, thereby exposing the first or second fluid line 15, 16 to the spray arms 7, 9. A connecting nozzle 28, to which the fluid line 14 from the circulation pump 13 can be connected, is molded in place in the distributor housing half 26 shown in FIG. 2.

According to FIG. 2 the actuator 23 is fitted by way of an inventive carrier element 29 on the distributor housing half 26 by way of the indicated screw connections 30.

FIG. 3 shows the carrier element 29 on its own. The carrier element 29 is a plastic part produced using a plastic injection molding method, with electric lines 31, 32, 33 cast therein in the manner of separate sheet metal plate parts. The lines 31, 32, 33 are shown on their own in FIG. 4. In the cast state according to FIG. 3 only their contact points are exposed from the plastic material of the carrier element 29. Thus according to FIGS. 3 and 4 the sheet metal plate parts 31, 32 have resilient contact arms 35 that each bend upward as first contact points for connection to the contact tongues 34 of the actuator 23 (FIG. 2). At their free upper ends these each have three stamped narrow contact webs, provided with additional grooves 36 to enhance their resilience. The contact arms 35 are therefore generally embodied in a flexible manner with the fitted actuator 23 for tolerance compensation purposes. The two sheet metal plate parts 31, 32 can be connected with their second exposed contact points 37 to a flat connector (not shown) for power supply purposes.

According to FIG. 3 the carrier element 29 has a plate-type, large-surface support segment 38, from the plane of which the two contact arms 35 project. The support segment 38 is enclosed by an outer boundary wall 39, in which opposing flexible latching tabs 40 are molded, being able to fix lateral latching tongues 41 of the electric motor 43 in place.

The exposed contact points 35, 37, 51, 52 are connected by way of flat sheet metal segments 56, 57 of the electric lines. These sheet metal segments 56, 57 extend in their entirety within the support segment 38 of the carrier element 29, parallel to one another and at a distance a over a large part of the carrier segment 38. The sheet metal segments 56, 57 cast in the carrier element 29 overall enhance the dimensional stability of the carrier element 29.

As shown in FIG. 5 the carrier element 29 with its peripheral boundary wall 39 is configured roughly in the manner of a dish and rests with the boundary wall 39 on the outside (shown simply with a broken line) of the distributor housing half 26. A gear train with toothed wheels 42, 43 is disposed in the gear chamber 55 formed between the carrier element 29 and the distributor housing half 26 according to FIG. 5. The gear train connects the drive shaft 44 of the actuator 23 to a force delivery shaft journal 45 that is rotationally actuatable by way of the distributor disk 21. To support the two toothed wheels 42, 43 the carrier element 29 features bearing segments in the form of a hollow cylindrical bearing stem 46 and a journal 47, both of which are molded on the carrier element 29 with material uniformity and as a single piece.

As also shown in FIGS. 2 and 3, water discharge openings 59 are provided in the carrier element 29 to conduct leakage water out of the gear chamber 55. The openings are disposed centrically around the journal 47 in the carrier element 29.

In its hub region the toothed wheel 42 has a hollow shaft 58, which rests with a form fit on outer teeth of the drive shaft 44. The centric hollow shaft 58 of the toothed wheel 42 is in sliding contact with the bearing stem 46 at its outer periphery. The toothed wheel 42 has a pan-type profile with a raised peripheral wall, on the upper peripheral edge of which a circular cam element 48 is molded, the cams of which can actuate a rotational position identification switch 49 described below.

The toothed wheel 42 meshes with the toothed wheel 43, the hollow cylindrical hub segment of which rests in sliding contact on the journal 47 of the carrier element 29. The hub segment of the toothed wheel 43 transitions in an axial direction downward into the force delivery shaft journal 45, on the outer teeth of which the distributor disk 21 rests with a form fit.

The control facility 25 of the dishwasher obtains feedback about the rotational position of the distributor disk 21 by means of the abovementioned rotational position identification switch 49. According to FIG. 5 the switch has two opposing switch contact points, each being configured on freely resilient contact arms 51, 52 of the two lines 31 and 33.

The switch 49 with its two contact arms 51, 52 is provided in the region of a window- type free space 53 within the support segment 38 of the carrier element 29 according to FIG. 3. The two lines 31, 33 with their contact arms 51, 52 therefore pass out of the boundary walls 50 of the free space 39, resulting in a switch facility that as a whole is resistant to vibrations and other interfering influences. The contact arm 52 here features an embossed abutment surface 54, against which the cams of the circular cam disk 48 can abut and are thus able to close a switching contact between the two contact arms 51, 52.

LIST OF REFERENCE CHARACTERS

1 Washing compartment

3, 5 Racks

7, 9 Spray arms

11 Pump sump

13 Circulation pump

14, 15, 16 Fluid lines

17 Fresh water inlet

18 Discharge line

19 Liquor pump

20 Distributor

21 Distributor disk, final control element

23 Electric actuator

25 Electronic control facility

26 Distributor housing half

27 Control openings in the distributor disk

28 Connecting nozzle

29 Carrier element

30 Screw connections

31, 32, 33 Sheet metal plates

34 Terminal contacts of actuator 23

35 First contact points of electric lines 31, 32

36 Grooves

37 Second contact points of electric lines 31, 32

38 Support segment of carrier element

39 Boundary wall

40 Latching element

41 Latching tongue

42, 43 Gear elements

44 Drive shaft

45 Drive element

46, 47 Bearing segments

48 Cam element

49 Position identification switch

50 Boundary walls

51, 52 Contact arms

53 Free space

54 Embossing

55 Gear chamber

56, 57 Sheet metal segments

59 Water discharge openings

a Distance between sheet metal segments 56, 57

1-23. (canceled)

24. A water-bearing domestic appliance, comprising:
a water diverter having a carrier element, the water diverter to distribute washing liquor; and
an actuator fastened to the carrier element;
wherein the carrier element is a cast part in which lines for actuating the actuator are embedded.

25. The water-bearing domestic appliance of claim 24, wherein the water-bearing domestic appliance is one of a dishwasher and a washing machine.

26. The water-bearing domestic appliance of claim 24, wherein the carrier element is produced by a plastic injection molding method and the lines are cast in the carrier element.

27. The water-bearing domestic appliance of claim 24, wherein the lines are electric lines.

28. The water-bearing domestic appliance of claim 27, wherein the electric lines are at least one of stamped and bent from a sheet metal plate.

29. The water-bearing domestic appliance of claim 24, wherein the electric lines have a first contact point for connection to the actuator and a second contact point for connection to a power supply connection.

30. The water-bearing domestic appliance of claim 24, further comprising a position identifier that is assigned to the actuator.

31. The water-bearing domestic appliance of claim 30, wherein the position identifier includes a switch having the lines with mutually contactable switch contact points.

32. The water-bearing domestic appliance of claim 31, wherein the carrier element has a recess in which the position identifier is disposed.

33. The water-bearing domestic appliance of claim 32, wherein the switch contact points of the lines project into the recess of the carrier element.

34. The water-bearing domestic appliance of claim 33, wherein the switch contact points are resilient contact arms.

35. The water-bearing domestic appliance of claim 24, wherein the carrier element has a support segment on which a component is disposed.

36. The water-bearing domestic appliance of claim 35, wherein the lines are embedded in the support segment of the carrier element.

37. The water-bearing domestic appliance of claim 30, wherein the actuator includes a drive shaft having a cam element which actuates the position identifier during rotation of the drive shaft.

38. The water-bearing domestic appliance of claim 37, wherein the carrier element has a bearing segment to support a gear element.

39. The water-bearing domestic appliance of claim 38, wherein the gear element is a toothed wheel.

40. The water-bearing domestic appliance of claim 38, wherein a first gear element rests on the drive shaft of the actuator and a second gear element connected thereto rests on a drive element driving a final control element.

41. The water-bearing domestic appliance of claim 40, wherein a cam element is embodied at least one of with material uniformity and as a single piece with one of the first and second gear elements.

42. The water-bearing domestic appliance of claim 38, wherein the bearing segment of the carrier element is a journal on which the gear element is supported in a rotatable manner.

43. The water-bearing domestic appliance of claim 38, wherein the bearing segment of the carrier element is a hollow cylindrical bearing stem, in which a hub segment of the gear element is supported in a rotatable manner.

44. The water-bearing domestic appliance of claim 38, wherein the bearing segment is molded with material uniformity and as a single piece on the carrier element.

45. The water-bearing domestic appliance of claim 24, wherein the carrier element has a latching element to latch a component to the carrier element.

46. The water-bearing domestic appliance of claim 40, wherein the final control element is a rotationally actuatable distributor disk of a distributor disposed in a hydraulic circuit of a dishwasher.
